(19) United States
(12) Patent Application Publication
(10) Pub. No.: US 2014/0334171 A1
(43) Pub. Date: Nov. 13, 2014

(54) LIGHTING DEVICE

(71) Applicant: Varroc Lighting Systems, s.r.o., Senov u Noveho Jicina (CZ)

(72) Inventors: Miroslav Kropac, Ostrava-Vyskovice (CZ); Libor Juttner, Suchdol nad Odrou (CZ); Ludek Mazal, Bilovec (CZ); Tomas Mateju, Ostrava Hrabuvka (CZ)

(73) Assignee: Varroc Lighting Systems, s.r.o., Senov u Noveho Jicina (CZ)

(21) Appl. No.: 14/275,410

(22) Filed: May 12, 2014

(30) Foreign Application Priority Data
May 13, 2013 (CZ) PV 2013-347

(51) Int. Cl. F21S 8/10

(52) U.S. Cl. CPC F21S 48/2225; F21S 48/2218; F21S 48/215
USPC 362/510; 362/511

(57) ABSTRACT

Lighting device, which is intended especially for external end lighting of motor vehicles, consists of an elongated light guide, provided with a light source at least at one of its ends and located in the space between the white rear cover of the lighting device and its front lens, while along the light guide on the side facing the front lens there is produced a transparent shielding filter in the form of a strip, for shielding the light guide, which is provided with a set of optical elements for directing the guided luminous flux onto the exit surface of the light guide, which is oriented in the direction of the internal surface of the white rear cover.

### CROSS-REFERENCES TO RELATED APPLICATIONS

This patent application claims priority to Czech Republic Patent Application Serial No. PV 2013/347 filed on May 13, 2013, which is incorporated herein by reference in its entirety.

### BACKGROUND OF THE INVENTION

The invention pertains to a lighting device, especially intended for the outside end lighting of motor vehicles.

At present, a lighting device is known, for example from KR 20120054120 (A), comprising a front lens, a light-reflecting element, a light conducting tube and a light source in the form of an LED. The reflecting element is provided with a white coating and the light conducting tube, having the light source arranged at one of its ends, is placed in the reflecting element, in front of which is arranged the front lens.

The drawback of this design is that the light conducting tube is visible through the front lens, so that the front lens does not send out light with constant intensity in all of its parts.

### SUMMARY OF THE INVENTION

In an exemplary embodiment, a lighting device, intended especially for external end lighting of motor vehicles is disclosed. The lighting device comprises an elongated light guide, provided with a light source at least at one of its ends and located in a space between a white rear cover of the lighting device and a front lens, wherein along the light guide on a side facing the front lens there is produced a transparent shielding filter in the form of a strip, for shielding the light guide, which is provided with a set of optical elements for directing a guided luminous flux onto an exit surface of the light guide, which is oriented in the direction of an internal surface of the white rear cover.

These and other advantages and features will become more apparent from the following description taken in conjunction with the drawings

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which a sample embodiment of the lighting device according to this invention is illustrated in the enclosed figures, of which:

FIG. 1 is a cross section of the lighting device;

FIG. 2 is one possible shape design of the elongated light guide, with light sources at both ends; and

FIGS. 3a and 3b show cross sections through the light guides with the exit surfaces provided with granulations (FIG. 3A) or made of milky or pigmented transparent material (FIG. 3B).

### DETAILED DESCRIPTION OF THE INVENTION

The aforementioned drawback is eliminated by the lighting device, intended especially for external end lighting of motor vehicles, consisting of an elongated light guide, provided with a light source at least at one of its ends and located in the space between the white rear cover of the lighting device and its front lens, according to this invention, whose essence lies in the fact that along the light guide on the side facing the front lens there is produced a transparent shielding filter in the form of a strip, for shielding the light guide, which is provided with a set of optical elements for directing the guided luminous flux onto the exit surface of the light guide, which is oriented in the direction of the internal surface of the white rear cover.

Another essence must be considered the fact that at least a portion of the exit surface of the light guide is provided with a granulation, or it is made from a milky or pigmented transparent material.

In an advantageous embodiment, the shielding transparent filter at least on one of its sides is provided with a granulation, or it is colored, while the light source is an LED.

The advantage of this structural design is that thanks to the shielding transparent filter the light guide cannot be seen, so that the front lens sends out light with constant intensity in all its parts.

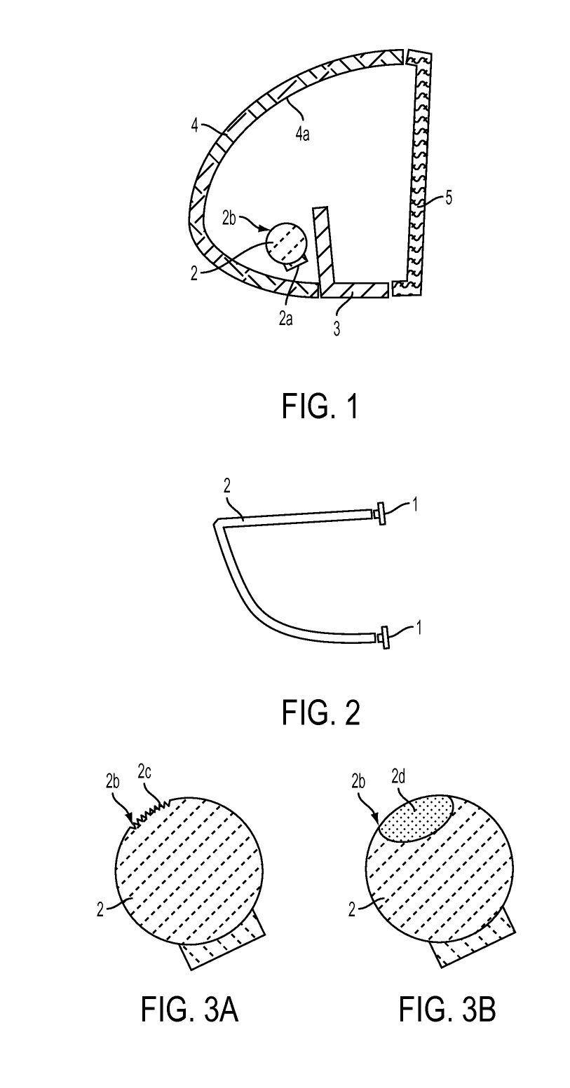

As can be seen from FIG. 1 and FIG. 2, the lighting device intended especially for external end lighting of motor vehicles, consists of an elongated light guide 2, provided with a light source 1 in the form of an LED at each of its ends and located in the space between the white rear cover 4 of the lighting device and its front lens 5.

Along the light guide 2 on the side facing the front lens 5 there is produced a transparent shielding filter 3 in the form of a transparent strip, for shielding the light guide 2. The light guide 2 itself is provided with a set of optical elements 2a for directing the guided luminous flux onto the exit surface 2b of the light guide 2, which is oriented in the direction of the internal surface 4a of the white rear cover 4.

In advantageous embodiments, at least part of the exit surface 2b of the light guide 2 can be provided with a granulation 2c, or is made of a milky or pigmented transparent material 2d.

In other advantageous embodiments, the shielding transparent filter 3 can be provided with granulation or be colored at least at one of its sides.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

1. A lighting device, intended especially for external end lighting of motor vehicles, consisting of an elongated light guide, provided with a light source at least at one of its ends and located in a space between a white rear cover of the lighting device and a front lens, wherein along the light guide on a side facing the front lens there is produced a transparent shielding filter in the form of a strip, for shielding the light guide, which is provided with a set of optical elements for directing a guided luminous flux onto an exit surface of the light guide, which is oriented in the direction of an internal surface of the white rear cover.

2. The lighting device according to claim 1, wherein at least a portion of the exit surface of the light guide is provided with a granulation.

3. The lighting device according to claim 1, wherein at least a portion of the exit surface of the light guide is provided with a granulation.

4. The lighting device according to claim 1, wherein the shielding transparent filter at least on one of its sides is provided with a granulation

5. The lighting device according to claim 1, wherein the shielding transparent filter is colored.

6. The lighting device according to claim 1, wherein the light source is an LED.

7. A lighting device, intended especially for external end lighting of motor vehicles, comprising an elongated light guide, provided with a light source at least at one of its ends and located in a space between a white rear cover of the lighting device and a front lens, wherein along the light guide on a side facing the front lens there is produced a transparent shielding filter in the form of a strip, for shielding the light guide, which is provided with a set of optical elements for directing a guided luminous flux onto an exit surface of the light guide, which is oriented in the direction of an internal surface of the white rear cover.
